(19) United States
(12) Patent Application Publication
(10) Pub. No.: US 2025/0337260 A1
(43) Pub. Date: Oct. 30, 2025

(54) LITHIUM-ION (Li-ion) BATTERY HEALTH DEGRADATION DETECTION IN FAST-CHARGING SYSTEMS

(71) Applicant: CIRRUS LOGIC INTERNATIONAL SEMICONDUCTOR LTD., Edinburgh (GB)

(72) Inventors: Markos Koseoglou, Austin, TX (US); Emmanuel A. Marchais, Dripping Springs, TX (US)

(21) Appl. No.: 18/651,172

(22) Filed: Apr. 30, 2024

(51) Int. Cl. H02J 7/00

(52) U.S. Cl. CPC H02J 7/005; H02J 7/0048; H02J 7/00714; H02J 7/007194

(57) ABSTRACT

A system detects degradation of battery health due to fast-charging and controls charging of the battery and/or provides indications of battery health while fast-charging. The system includes remove a battery charging circuit that controls a charging voltage waveform to supply charging current to a battery and a detection circuit that monitors a rate of change of the charging current and controls the charging voltage waveform responsive to an output of the detection circuit.

### BACKGROUND

### 1. Field of Disclosure

The field of representative embodiments of this disclosure relates to battery charging systems, battery charging methods, and in particular, to detection techniques in a fast-charging battery charging system that detects health degradation in Lithium-Ion batteries.

### 2. Background

In battery-powered portable devices, such as mobile telephones, tablets, notebook computers, along with other battery-operated devices, battery charging and monitoring systems provide for both off-line and on-line charging of device batteries. Fast-charging systems, which provide rapid restoration of battery charge, are typically controlled by sophisticated algorithms that control both the charging rate and maximum charge applied to the batteries, in order to preserve long-time life of the batteries and the ability of the batteries to deliver sufficient charge, i.e., to maintain battery health. The charging algorithms typically use measures of battery health to determine how fast and how much to charge a battery, and typically use a constant current constant-voltage (CCCV) pattern perform the charging. CCCV patterns charge with a constant current until the battery terminal voltage reaches a predetermined level, and then changes to constant voltage charging after the predetermined terminal voltage has been reached.

However, CCCV charging is not necessarily an optimum charging pattern over all battery conditions and charging control based on battery state-of-health (SOH) would generally be preferable, in order to avoid degrading the SOH. While existing battery health monitoring algorithms provide detection of battery health degradation within a battery, they are significantly dependent on a highly variable state of the battery, which includes cell temperature, the state of charge (SOC) of the battery and the state of health (SOH) of the battery, which causes difficulties in evaluating battery health degradation of the battery during charging. Therefore, more advanced fast-charging algorithms used in fast-charging Li-ion batteries typically use a physics-based model (PBM), a Lithium plating detection scheme, or a combination of both, to determine charging patterns, e.g., to determine charging current levels over time. However, degradation of the battery SOH complicates adjustment of the PBM control in real-time, and therefore charging patterns based on offline studies are typically used.

Therefore, it would be advantageous to provide a battery health degradation mechanism for charging systems and a detection method that can be used in real-time battery monitoring and fast-charging systems.

### SUMMARY

The objectives of providing real-time battery health monitoring during fast-charging is accomplished in a system and its method of operation.

The system includes a battery charging circuit that controls a charging voltage waveform to supply charging current to a battery and a detection circuit that monitors a rate of change of the charging current and controls the charging voltage waveform responsive to an output of the detection circuit.

The summary above is provided for brief explanation and does not restrict the scope of the claims. The description below sets forth example embodiments according to this disclosure. Further embodiments and implementations will be apparent to those having ordinary skill in the art. Persons having ordinary skill in the art will recognize that various equivalent techniques may be applied in lieu of, or in conjunction with, the embodiments discussed below, and all such equivalents are encompassed by the present disclosure.

### BRIEF DESCRIPTION OF THE DRAWINGS

FIG. 1 is a block diagram illustrating an example system 10, in accordance with an embodiment of the disclosure.

FIG. 2 is a block diagram illustrating an example charging control circuit 20A, that may be used to implement charging control circuit 20 in example system 10 of FIG. 1, in accordance with an embodiment of the disclosure.

FIG. 3 is a block diagram illustrating an example battery degradation detection circuit 30, that may be used to perform a portion of the operations of charging control circuit 20 in example system 10 of FIG. 1, in accordance with an embodiment of the disclosure.

FIG. 4 is a block diagram illustrating an example process that may be performed by charging control circuit 20 in example system 10 of FIG. 1, in accordance with an embodiment of the disclosure.

FIG. 5 is a flowchart 50 illustrating an example method of processing that may be performed within example charging control circuit 20 in example system 10 of FIG. 1, in accordance with an embodiment of the disclosure.

FIG. 6A and FIG. 6B are graphs 60A and 60B, respectively, depicting signal waveform diagrams illustrating operation of example system 10, in accordance with an embodiment of the disclosure.

FIG. 7A and FIG. 7B are graphs 70A and 70B, respectively, depicting example battery charging current characteristics of an example battery that may be charged by example system 10, in accordance with an embodiment of the disclosure.

FIG. 8A and FIG. 8B are graphs 80A and 80B, respectively, depicting example battery charging current derivative characteristics of an example battery that may be charged by example system 10, in accordance with an embodiment of the disclosure.

FIG. 9A and FIG. 9B are graphs 90A and 90B, respectively, depicting example overall battery charging characteristics of an example battery that may be charged by example system 10, in accordance with an embodiment of the disclosure.

### DETAILED DESCRIPTION OF ILLUSTRATIVE EMBODIMENT

The present disclosure encompasses battery charging systems, battery charging circuits, battery health monitors and their methods of operation. The systems include a battery charging circuit that controls a charging voltage waveform to supply charging current to a battery and a detection circuit that monitors a rate of change of the charging current and controls the charging voltage waveform responsive to an output of the detection circuit. Rather than charging with a CCCV technique, the systems and methods disclosed herein may produce a piece-wise constant voltage output waveform that is controlled according to profiles determined for particular battery condition, including temperature, SOC and SOH. At each voltage level, the battery current is exponentially decreasing, and by observing conditions such as battery current, and the derivatives of the battery current with respect to SOC, the battery charging can be tailored to prevent degradation of battery health that will otherwise occur by applying too great a current at a given battery temperature, SOC and SOH. The disclosed systems may use a tracking envelope defined by an upper and lower bound that change over time with the battery temperature, SOC, and SOH to ensure that a safe charging profile is sufficiently met over each stage of the overall battery charging profile.

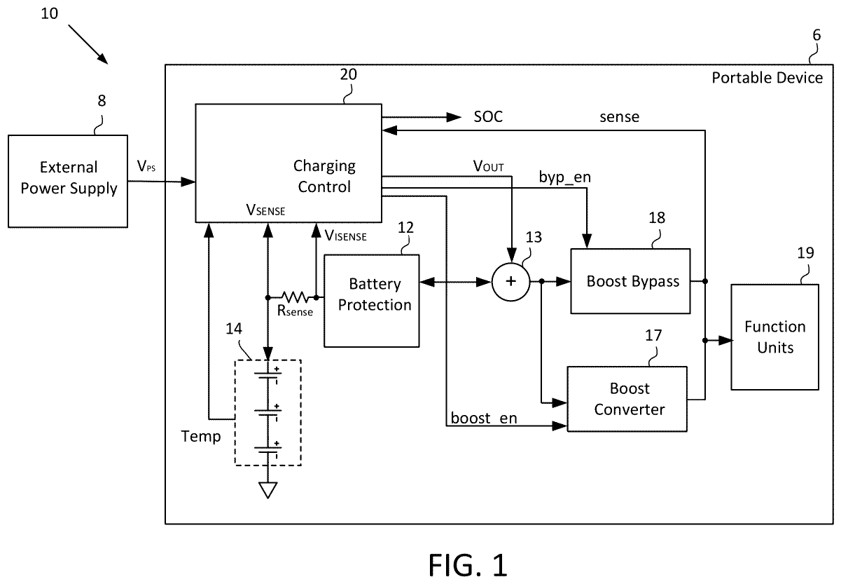

Referring now to FIG. 1, a block diagram illustrating an example system 10 is shown, in accordance with an embodiment of the disclosure. Example system 10 includes an external power supply 8 and a personal device 6 that receives a power supply voltage V_{PS} and applies received power to operation of portable device and charging of an internal battery 14, which is generally a Li-ion battery. A battery protection circuit 12 provides over-current and over-voltage protection on the connection to battery 14 from a combiner 13 that combines the load of battery charging and the operation of function units 19, which are coupled to combiner 13 by a power supply path that includes a boost converter 17, which ordinarily operates when the battery output voltage from battery protection circuit 12 is lower than that required by functional units 19. When the battery output voltage from battery protection circuit 12 is sufficient, a boost bypass circuit 18 that directs battery current directly to function units 19 is activated. The combined operation of boost converter 17 and boost bypass circuit 18 regulate the voltage provided from battery 14 to function units 19. Charging control circuit 20, in addition to controlling whether or not boost converter 17 or boost bypass circuit 18 is active during ordinary operation by controlling the state of control signals boost_en and byp_en, respectively, performs measurements to determine the state-of-charge SOC and state-of-health (SOH) of battery 14. Charging control circuit 20 also provides a controlled output voltage V_{OUT} to charge battery 14, according to various control techniques as described in further detail below, which preserve the health of battery 14 by detecting characteristics of the charging current that indicate that the health of battery 14 is being degraded, and changing the charging voltage supplied to battery 14. A battery sense voltage V_{SENSE} may be provided directly from the terminals of battery 14, to accurately control the terminal voltage imposed on battery by output voltage V_{OUT}. A sense resistor R_{SENSE} may be included in series between battery protection circuit 12 and battery 14 to provide a voltage V_{ISENSE} indicative of the battery current. A temperature sensor (or temperature information received from smart battery) provides battery temperature indication Temp that may be used to inform the control of the charging voltage provided to battery 14, as the selected charging pattern for controlling the charging voltage may be varied with battery temperature, as well as SOC and SOH. By detecting the initial onset of likely health degradation within battery 14, charging can be halted or slowed, preventing or reducing degradation in the SOH of battery 14.

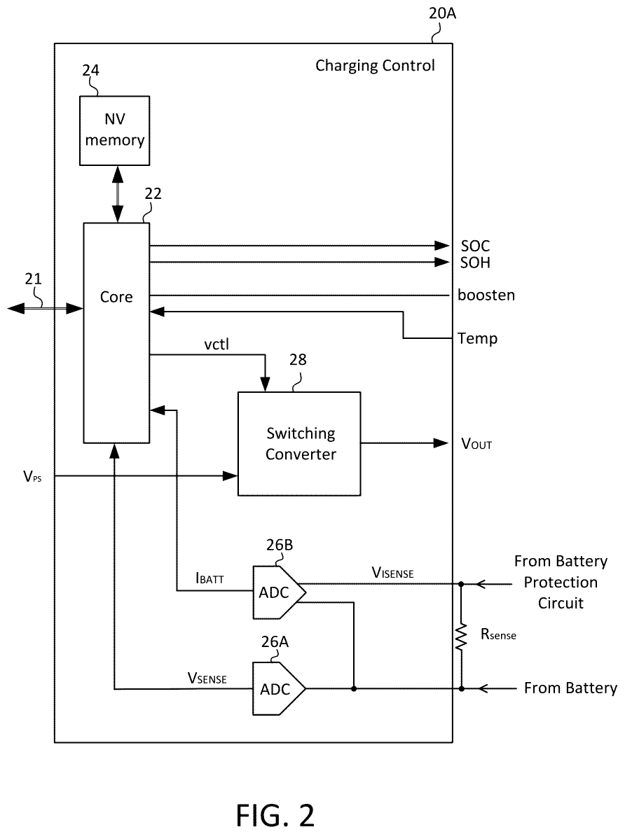

Referring now to FIG. 2, a block diagram illustrating an example charging control circuit 20A, that may be used to implement charging control circuit 20 in example system 10 of FIG. 1 is shown, in accordance with an embodiment of the disclosure. Within charging control circuit 20A, a core 22, which may be a microprocessor core, microcontroller core, state machine, or another suitable processor, implements the measurement and charge control algorithms described herein, in order to control the charging voltage applied to battery 14 in example system 10 of FIG. 1, by dynamically changing control values v_{CTL} supplied to a switching converter 28, which may be implemented as a buck converter or a buck-boost converter, depending on system requirements. An analog-to-digital converter (ADC) 26A receives battery voltage sense signal Vₛₑₙₛₑ, which in the instant example, is an indication of the voltage across battery 14, e.g., from a voltage divider connected to the positive terminal of battery 14. Another ADC 26B measures the difference between battery voltage sense signal V_{SENSE} and battery current sense signal V_{ISENSE} to generate a battery current value I_{batt}. Core 22 may be coupled to a non-volatile memory (NV) 24 that may store program code executed by core 22 and forming a computer-program product in accordance with an embodiment of the disclosure to implement the measurement, detection and control algorithms described herein. Core 22 may also compute measures of the SOC and SOH of battery 14 and provide output SOC and SOH values used by other subsystems, including condition monitoring displays.

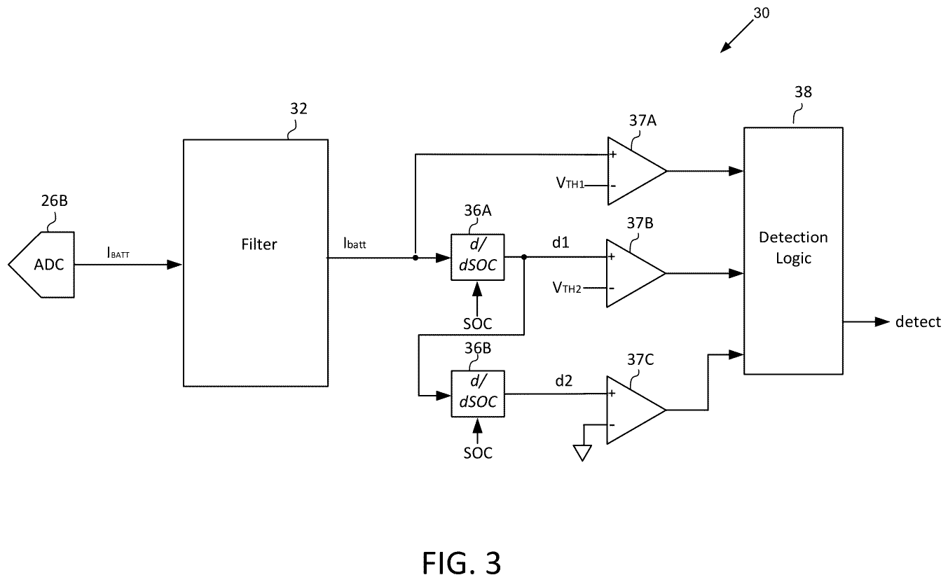

Referring now to FIG. 3, a block diagram illustrating an example battery degradation detection circuit 30, that may be used to perform a portion of the operations of charging control circuit 20 in example system 10 of FIG. 1 is shown, in accordance with another embodiment of the disclosure. The output of ADC 26B, which provides battery current value I_{batt} to a digital filter 32 that filters the current values with a low-pass characteristic to remove noise and that may, along with subsequent processing blocks, be implemented by a program executed by core 22 within charging control circuit 20A of FIG. 2. Alternatively, digital filter 32 and subsequent processing blocks may be implemented by a dedicated circuit. A differentiator block 36A produces an output corresponding to a first derivative d1 of battery current value I_{batt} with respect to the SOC of battery 14 of FIG. 1. Another differentiator block 36B is optionally included to differentiate the output of differentiator block 36A to produce an output corresponding to a second derivative d2 of battery current value I_{batt} with respect to the SOC of battery 14. A comparator 37A compares battery current value I_{batt} to a first threshold value V_{TH1}, a second comparator 37B compares the first derivative d1 of battery current value I_{batt} with respect to the SOC to a second threshold value V_{TH2}, and a third comparator 37C optionally compares the second derivative d2 of battery current value I_{batt} with respect to the SOC to zero, to detect zero-crossings of the first derivative d1 that indicate a local maxima or local minima has occurred in the first derivative d1 of battery current value I_{batt} with respect to SOC. A detection logic block 38 combines the outputs of comparators 37A, 37B and 37C to provide an indication detect that indicates the present charging conditions will likely degrade the health of battery 14.

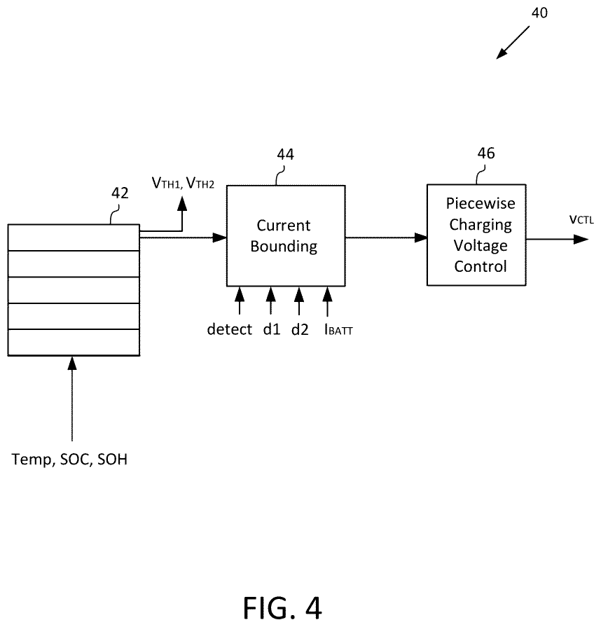

Referring now to FIG. 4, a block diagram illustrating an example process that may be performed by charging control circuit 20 in example system 10 of FIG. 1 is shown, in accordance with an embodiment of the disclosure. A plurality of charging profiles or parameters representing the charging profiles may be stored in a look-up table 42, that is indexed by battery temperature Temp, along with the battery SOC and SOH. Look-up table 42 provides outputs, that for example, may include first threshold value V_{TH1} and second threshold value V_{TH2} that are applied in example battery degradation detection circuit 30 of FIG. 3. A current bounding block 44 receives inputs that may include indication detect and first derivative value d1 produced by degradation detection circuit 30, as well as battery current value I_{batt}. From the input values, current bounding block 44 provides an output to a piecewise charging voltage control block that updates voltage control value vctl to control the piecewise constant output voltage waveform V_{OUT} generated by switching converter 28 of example charging control circuit 20A of FIG. 2. By using a bounded current model stored for various temperature ranges, not only may battery health degradation be avoided by controlling output voltage V_{OUT}, which in turn controls battery charging voltage V_{SENSE}, but a minimum charging rate may also be controlled as appropriate for battery temperature Temp and SOC/SOH of battery 14. The profiles stored in look-up table 42 may be determined off-line for each temperature range and represent safe charging profiles for each range of SOC for the temperatures and for SOH over the life of the battery represented by the profile. The safe profiles may be safe slow-charging profiles, or faster charging profiles for which degradation has not been observed.

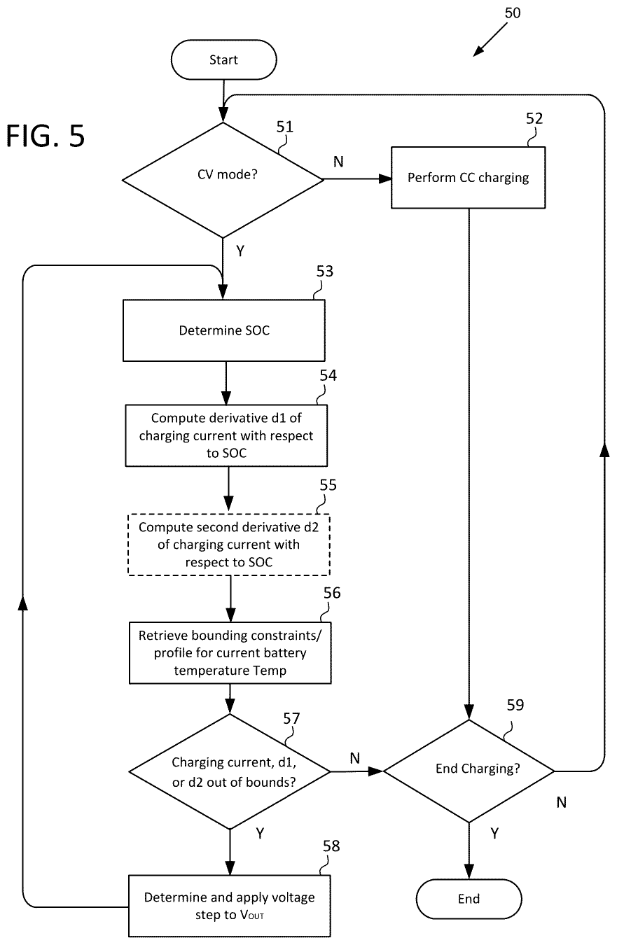

Referring now to FIG. 5, a flowchart 50 illustrating an algorithm that may be performed within example charging control circuit 20 in example system 10 of FIG. 1 is shown, in accordance with an embodiment of the disclosure. Flowchart 50 is an example of an algorithm that may be implemented by the above-described computer program product executed by core 22 in example charging control circuit 20A of FIG. 2 and also represents the example implementations described above with reference to FIGS. 1-4. If charging circuit 20 is not selected for constant voltage (CV) mode (decision 51) then constant current (CC) charging is performed (step 52). As is well known, when a Li-Ion battery's terminal voltage is less than a predetermined value, the charging current must be limited, and therefore the piece-wise constant voltage (CV) mode should not be initiated until a certain minimum SOC is achieved. If charging circuit 20 is selected for constant voltage (CV) mode (decision 51), then the SOC of battery 14 is determined (step 53), the first derivative d1 of charging current I_{batt} is computed (step 54), and optionally the second derivative d2 of charging current I_{batt} is computed (step 55). The boundary constraints or profile for the present battery temperature are retrieved (step 56), and if the charging current I_{batt}, the first derivative d1, and optionally the second derivative d2 are out of bounds (decision 57), then a step change to output voltage V_{OUT} is computed and applied (step 58). Until charging is ended (decision 59), the process of steps 51-59 is repeated.

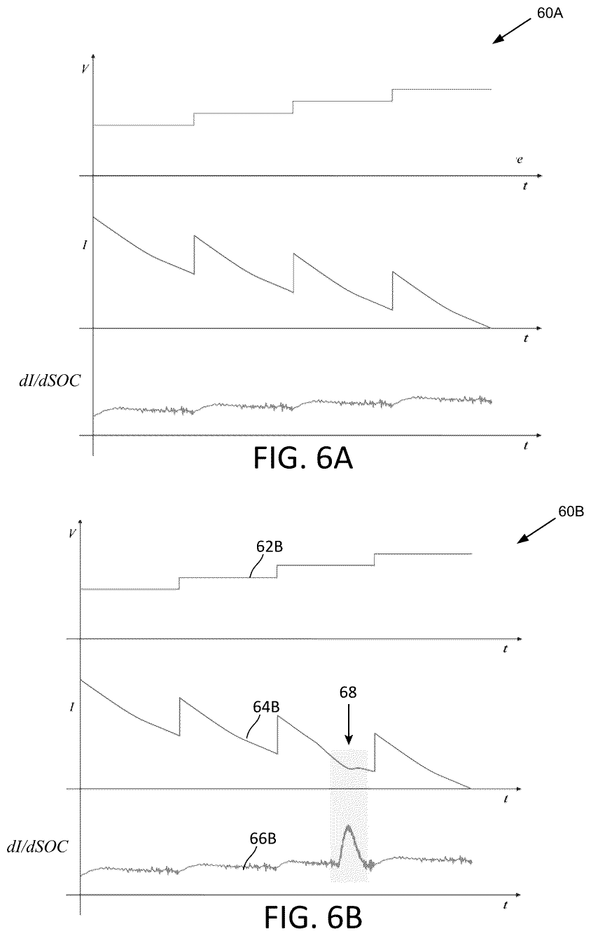

Referring now to FIG. 6A and FIG. 6B, graphs 60A and 60B, respectively, depicting signal waveform diagrams illustrating operation of example system 10 are shown, in accordance with an embodiment of the disclosure. In graph 60A of FIG. 6A, waveform 64A shows segments of exponentially decreasing battery current value I_{batt} corresponding to the charging current provided to battery 14, while waveform 62A shows the steps in voltage V_{OUT} that are produced to continue safely charging battery 14. Waveform 66A is a graph of first derivative d1 of battery current value I_{batt}, which exhibits nominally constant steps corresponding to slopes of the segments of battery current value I_{batt}, which progressively increase in slope. In contrast, in graph 60B of FIG. 6B, while waveform 64B shows similar segments of exponentially decreasing battery current value I_{batt} produced by similar steps in in voltage V_{OUT} shown in waveform 62B, in region 68, the charging current waveform deviates from the nominally linear behavior, which is indicated by an abrupt peak in waveform 66B, which is the first derivative d1 of the charging current shown in waveform 64B, illustrating operation without the adjustments of charging voltage waveform provided in example system 10, which would decrease voltage V_{OUT} as soon as the deviation of first derivative d1 from a nominal value and/or as soon as the shape of battery current value I_{batt} deviated from the expected stored profile illustrated by waveform 64A.

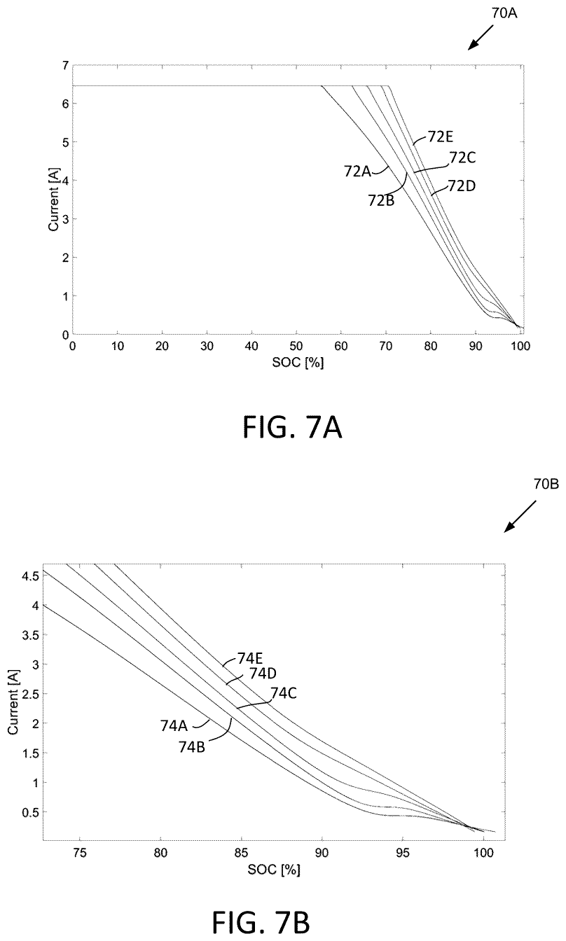

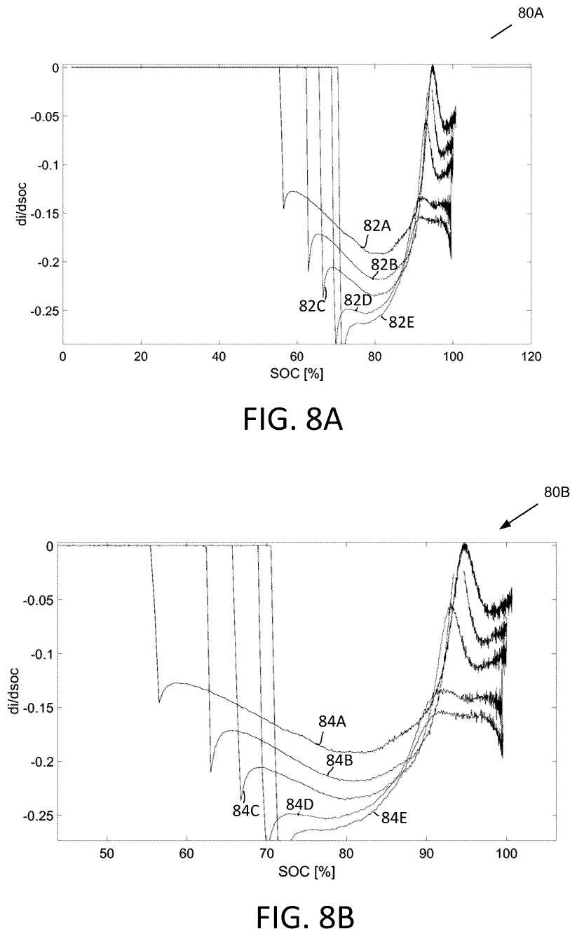

Referring now to FIG. 7A and FIG. 7B, graphs 70A and 70B, respectively, depicting example battery charging current characteristics of an example battery that may be charged by example system 10 are shown, in accordance with an embodiment of the disclosure. Waveforms 72A-72E are graphs for progressively increasing temperature ranges, with graph 72A representing a constant-voltage charging current profile vs. SOC for a battery temperature Temp of 25° C., graph 72B representing a constant-voltage charging current profile vs. SOC for a battery temperature Temp of 30° C., and so forth, in 5-degree steps through graph 72E corresponding to a battery temperature Temp of 45° C. Subsequent graphs shown in FIG. 7B, FIGS. 8A-8B follow the same convention, with suffix “A” indicating a battery temperature Temp of 25° C. and so forth up to suffix “E” indicating a battery temperature Temp of 45° C. Between 90% and 100% SOC, the charging current profiles deviate from nominally linear decrease for battery temperatures below 40° C., demonstrating that for temperatures above that range, a signature does not generally need to be stored, and the algorithm that controls the piece-wise linear voltage stepping of example system 10 may be allowed to proceed without altering charging behavior to reduce the charging voltage. However, for temperatures below 40° C., signatures may be stored in lookup table 42 and compared to battery current value I_{batt} during charging, as well a comparing the value of first derivative d1 and optionally second derivative d2 should be observed for zero-crossings to detect local maxima such as the peak in region 68 in waveform 66B of FIG. 6B. Graph 70B shows an expanded view of graph 70A for SOC values between 75% and 100%, illustrating more clearly the decreases in charging current slope occurring at temperatures below 40° C.

Referring now to FIG. 8A and FIG. 8B, graphs 80A and 80B, respectively, depicting example battery charging current derivative d1 characteristics of an example battery that may be charged by example system 10 are shown, in accordance with an embodiment of the disclosure. As illustrated by graph 80A, signal waveforms 82D and 82E, do not show significant peaks, but signal waveforms 82A-82C each have a peak in the vicinity of 90% SOC, indicating likely degradation of battery 14. Graph 80B shows an expanded view of graph 80A for SOC values between 55% and 100%, illustrating more clearly the peaks in the charging current derivative d1 at temperatures below 40° C. and at SOC between 90% and 95%.

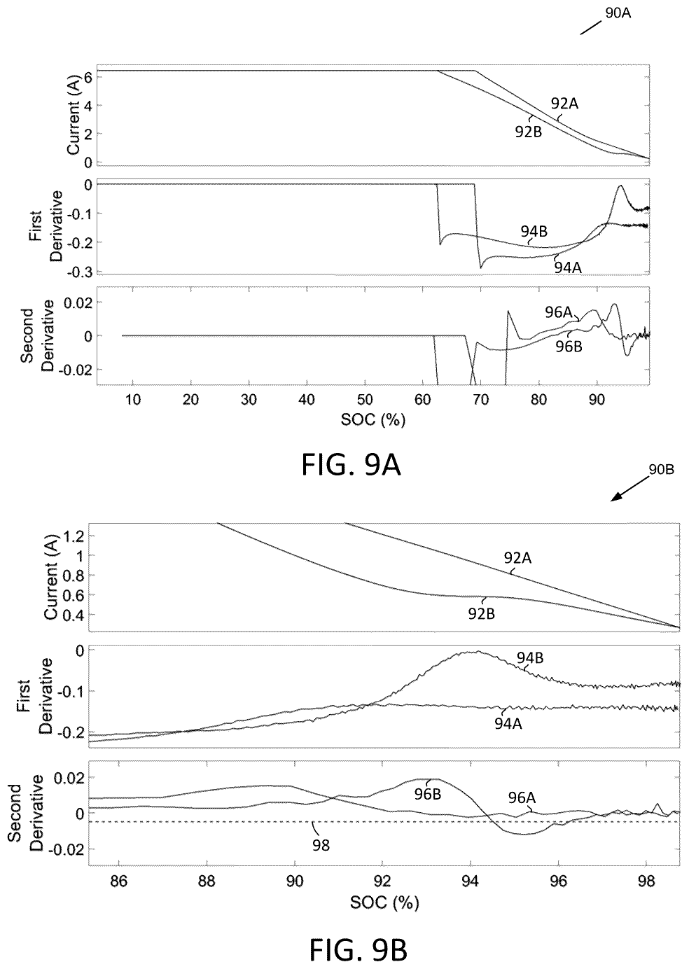

Referring now to FIG. 9A and FIG. 9B, graphs 90A and 90B, respectively, depicting example overall battery charging characteristics of an example battery that may be charged by example system 10 are shown, in accordance with an embodiment of the disclosure. In graph 90A of FIG. 9A, waveforms 92A, 94A and 96A correspond to a baseline safe charging profile, where waveform 92A is battery current value I_{batt}, waveform 94A is first derivative d1 and waveform 96A is second derivative d2. Waveforms 92B, 94B and 96B correspond to a fast-charging profile, where waveform 92B is battery current value I_{batt}, waveform 94B is first derivative d1 and waveform 96B is second derivative d2. Graph 90B of FIG. 9B shows an expanded view of graph 90A for SOC values between 55% and 100%, illustrating more clearly the local zero crossings of second derivative d2 for the fast-charging profile in waveform 96B. A (constant) threshold represented by waveform 98 may optionally be applied to zero-crossing detection of second derivative d2, in order to prevent noise from mis-triggering detection of battery health degradation using derivative d2 as an indicator.

As mentioned above, portions or all of the disclosed process may be carried out by a state machine, which may be provided by a logic circuit, or the execution of a collection of program instructions forming a computer program product stored on a non-volatile memory, and executed by a controller core. Such programs may also exist outside of the non-volatile memory in tangible forms of storage forming a computer-readable storage medium. The computer-readable storage medium may be, for example, but is not limited to, an electronic storage device, a magnetic storage device, an optical storage device, an electromagnetic storage device, a semiconductor storage device, or any suitable combination of the foregoing. Specific examples of the computer-readable storage medium include the following: a hard disk, semiconductor volatile and non-volatile memory devices, a portable compact disc read-only memory (CD-ROM) or a digital versatile disk (DVD), a memory stick, a floppy disk or other suitable storage device not specifically enumerated. A computer-readable storage medium, as used herein, is not to be construed as being transitory signals, such as transmission line or radio waves or electrical signals transmitted through a wire. It is understood that blocks of the block diagrams described above may be implemented by computer-readable program instructions. These computer readable program instructions may also be stored in other storage forms as mentioned above and may be downloaded into a non-volatile memory for execution therefrom. However, the collection of instructions stored on media other than the non-volatile memory described above also form a computer program product that is an article of manufacture including instructions which implement aspects of the functions/actions specified in the block diagram block or blocks, as well as method steps described herein.

It should be understood, especially by those having ordinary skill in the art with the benefit of this disclosure, that the various operations described herein, particularly in connection with the figures, may be implemented by other circuitry or other hardware components. The order in which each operation of a given method is performed may be changed, and various elements of the systems illustrated herein may be added, reordered, combined, omitted, modified, etc. It is intended that this disclosure embrace all such modifications and changes and, accordingly, the above description should be regarded in an illustrative rather than a restrictive sense. Similarly, although this disclosure makes reference to specific embodiments, certain modifications and changes may be made to those embodiments without departing from the scope and coverage of this disclosure. Moreover, any benefits, advantages, or solutions to problems that are described herein with regard to specific embodiments are not intended to be construed as a critical, required, or essential feature or element.

In summary, this disclosure shows and describes a system and its method of operation. The system includes a battery charging circuit that controls a charging voltage waveform to supply charging current to a battery and a detection circuit that monitors a rate of change of the charging current and controls the charging voltage waveform responsive to an output of the detection circuit.

In some example embodiments, the battery charging circuit may produce a piecewise-constant charging voltage waveform, with voltages of the piecewise-constant charging voltage waveform set in response to the output of the detection circuit. In some example embodiments, the detection circuit may monitor the rate of change of the charging current by comparison to one or more degradation signatures, and reduce or terminate the charging voltage waveform in response to detecting that the rate of change of the charging current matches a degradation signature. In some example embodiments, the detection circuit may calculate a derivative of the charging current with respect to time and a state of charge of the battery.

In some example embodiments, the system may further include a battery health indication circuit that may provide indications of health of the battery, and the derivative of the charging current may be used to provide the battery health indication. In some example embodiments, an output of the battery health indication circuit may either directly control the battery charging circuit according to the indications of health of the battery, or the battery charging circuit may operate according to a health-aware fast-charging profile determined from the indications of health of the battery. In some example embodiments, the detection circuit may further calculate a second derivative of the charging current with respect to time and the state of charge of the battery, and the second derivative of the charging current may be used along with the derivative of the charging current to provide the battery health indication.

In some example embodiments, the detection circuit may compare the calculated derivative of the charging current to one or more nominal profiles determined for a slow-charging process that does not degrade the health of the battery. In some example embodiments, the detection circuit may compare a shape of the calculated derivative of the charging current to the one or more nominal profiles. In some example embodiments, the one or more nominal profiles may be stored in a look-up table indexed by operating temperature, and the system may further include a temperature monitor that provides an operating temperature as the index to the look-up table. In some example embodiments, the battery charging circuit may further control either the charging current or values of the charging voltage waveform according to values of the charging current, a state-of-charge of the battery, and the rate of change of the charging current. In some example embodiments, the battery charging circuit may select one of a plurality of charging voltage waveforms according to a battery temperature. In some example embodiments, the plurality of charging voltage waveforms may be predetermined from measurements of safe charging profiles corresponding to multiple battery temperatures on a test battery.

While the disclosure has shown and described particular embodiments of the techniques disclosed herein, it will be understood by those skilled in the art that the foregoing and other changes in form, and details may be made therein without departing from the spirit and scope of the disclosure. For example, the techniques shown above may be applied to other types of battery chargers and battery health monitoring systems

What is claimed is:

1. A system, comprising:
a battery charging circuit that controls a charging voltage waveform to supply charging current to a battery; and
a detection circuit that monitors a rate of change of the charging current and controls the charging voltage waveform responsive to an output of the detection circuit.

2. The system of claim 1, wherein the battery charging circuit produces a piecewise-constant charging voltage waveform, with voltages of the piecewise-constant charging voltage waveform set in response to the output of the detection circuit.

3. The system of claim 1, wherein the detection circuit monitors the rate of change of the charging current by comparison to one or more degradation signatures, and reduces or terminates the charging voltage waveform in response to detecting that the rate of change of the charging current matches a degradation signature.

4. The system of claim 1, wherein the detection circuit calculates a derivative of the charging current with respect to time and a state of charge of the battery.

5. The system of claim 4, further comprising a battery health indication circuit that provides indications of health of the battery, and wherein the derivative of the charging current is used to provide the battery health indication.

6. The system of claim 5, wherein an output of the battery health indication circuit either directly controls the battery charging circuit according to the indications of health of the battery, or wherein the battery charging circuit operates according to a health-aware fast-charging profile determined from the indications of health of the battery.

7. The system of claim 5, wherein the detection circuit further calculates a second derivative of the charging current with respect to time and the state of charge of the battery, and wherein the second derivative of the charging current is used along with the derivative of the charging current to provide the battery health indication.

8. The system of claim 4, wherein the detection circuit compares the calculated derivative of the charging current to one or more nominal profiles determined for a slow-charging process that does not degrade the health of the battery.

9. The system of claim 8, wherein the detection circuit compares a shape of the calculated derivative of the charging current to the one or more nominal profiles.

10. The system of claim 8, wherein the one or more nominal profiles are stored in a look-up table indexed by operating temperature, and wherein the system further includes a temperature monitor that provides an operating temperature as the index to the look-up table.

11. The system of claim 1, wherein the battery charging circuit further controls either the charging current or values of the charging voltage waveform, according to values of the charging current, a state-of-charge of the battery and the rate of change of the charging current.

12. The system of claim 1, wherein the battery charging circuit selects one of a plurality of charging voltage waveforms according to a battery temperature.

13. The system of claim 12, wherein the plurality of charging voltage waveforms is predetermined from measurements of safe charging profiles corresponding to multiple battery temperatures on a test battery.

14. A method of controlling a charging voltage waveform supplied to a battery, comprising:
monitoring a rate of change of a charging current produced at terminals of the battery by the charging voltage waveform; and
controlling a profile of the charging voltage waveform responsive to a result of the monitoring.

15. The method of claim 14, wherein the charging voltage waveform is a piecewise-constant charging voltage waveform, with voltages of the piecewise-constant charging voltage waveform set in response to the result of the monitoring.

16. The method of claim 14, wherein the monitoring monitors the rate of change of the charging current by comparing the rate of change of the charging current to one or more degradation signatures, and wherein the controlling reduces or terminates the charging voltage waveform in response to detecting that the rate of change of the charging current matches a degradation signature.

17. The method of claim 14, wherein the monitoring comprises calculating a derivative of the charging current with respect to time and a state of charge of the battery.

18. The method of claim 17, further comprising providing indications of health of the battery determined from the derivative of the charging current.

19. The method of claim 18, further comprising calculating a second derivative of the charging current with respect to time and the state of charge of the battery, and wherein the second derivative of the charging current is used by the providing of the indications of the health of the battery, along with the derivative of the charging current, to provide the indications of health of the battery health.

20. The method of claim 18, further comprising controlling the battery charging current according to the indications of health of the battery or controlling the battery charging current according to a health-aware fast-charging profile determined from the indications of health of the battery.

21. The method of claim 17, wherein the monitoring compares the calculated derivative of the charging current to one or more nominal profiles determined for a slow-charging process that does not degrade the health of the battery.

22. The method of claim 21, wherein the monitoring compares a shape of the calculated derivative of the charging current to the one or more nominal profiles.

23. The method of claim 21, further comprising:
monitoring an operating temperature of the battery; and
retrieving one of the nominal profiles according to the current operating temperature of the battery for comparison to the calculated derivative.

24. The method of claim 14, further comprising controlling either the charging current or values of the charging voltage waveform according to values of the charging current, a state-of-charge of the battery and the rate of change of the charging current.

25. The method of claim 14, further comprising selecting one of a plurality of charging voltage waveforms according to a temperature of the battery.

26. The method of claim 25, wherein the plurality of charging voltage waveforms is predetermined from measurements of safe charging profiles corresponding to multiple battery temperatures on a test battery.
